(19) United States
(12) Patent Application Publication
(10) Pub. No.: US 2011/0295597 A1
(43) Pub. Date: Dec. 1, 2011

(54) SYSTEM AND METHOD FOR AUTOMATED ANALYSIS OF EMOTIONAL CONTENT OF SPEECH

(76) Inventor: Patrick K. Brady, Glen Ellyn, IL (US)

(21) Appl. No.: 13/116,720

(22) Filed: May 26, 2011

Related U.S. Application Data
(60) Provisional application No. 61/396,446, filed on May 26, 2010.

(51) Int. Cl. G10L 11/00

(52) U.S. Cl. 704/201; 704/E11.001

(57) ABSTRACT

A method and apparatus for automated analysis of emotional content of speech is presented. Telephony calls are routed via a network such as public service telephone network (PSTN) and delivered to an interactive voice response system (IVR) where prerecorded or synthesized prompts guide a caller to speech responses. Speech responses are analyzed for emotional content in real time or collected via recording and analyzed in batch. If performed in real time, results of emotional content analysis (ECA) may be used as input to IVR call processing and call routing. In some applications this might involve ECA input to expert system process whose results interact with an IVR for prompt creation and call processing. In any case, ECA data is valuable on its own and may be culled and restated in the form of reports for business application.

### CROSS-REFERENCE TO RELATED APPLICATIONS

This application claims priority to U.S. Provisional Patent Application, Ser. No. 61/396,446, filed on May 26, 2010, titled “Method for Automated Analysis of Emotional Content of Speech” the contents of which are hereby incorporated by reference in their entirety.

### BACKGROUND OF THE INVENTION

1. Field of the Invention

The present invention deals with methods and apparatus for automated analysis of emotional content of speech.

2. Discussion of the State of the Art

Methods for determining emotional content of speech are beginning to come to market. Several providers of such systems provide for analysis of speech streamed from digitized sources such as pulse-code modulated PCM (signals) of telephony systems. Many applications of emotional content analysis (ECA) involve caller contact where it is desirable to automate an interaction. Such automation presents unique problems for ECA systems.

Interactive voice response (IVR) technology is well known and the market for it is well developed. IVR systems may be owned and operated in-house by corporations or they may be deployed as shared services provided by a central provider. In-house systems provide an environment for collocating ECA technology within an IVR. Shared service environments lend themselves to batch post-processing or collocated ECA server processing systems as described below.

### SUMMARY OF THE INVENTION

The present invention seeks to provide an apparatus and method for automating ECA in telephony applications. There is thus provided, in accordance with a preferred embodiment, apparatus for receiving and processing calls, apparatus for storing and playing pre-recorded or synthesized prompts and for storing speech responses, apparatus for interconnecting computers, and apparatus for performing ECA.

In a typical application, calls are routed via a network such as a public switched telephony network (PSTN) to an IVR system. Calls are answered and a greeting prompt is played. Callers answers questions by speaking after one or more prompts. In one preferred embodiment this customer speech is stored in a file. These files may be moved in batch during off hours for ECA processing on another server. The naming and handling of such files is managed by software, which is part of an Automated ECA System (AES). Data collected from such ECA work are assembled into reports by an AES.

In another preferred embodiment, calls routed by a PSTN are delivered to an IVR system that has real time ECA technology capability. In this embodiment ECA is performed on responses to IVR prompts. Results are then immediately available for call processing within the IVR. In a simple example this might mean playing a particular one from a set of follow-up prompts depending at least in part on an ECA result. In a more sophisticated application ECA results may be used in conjunction with expert system technology to cause unique prompt selection or prompt creation based on a current context of a caller, inference engine results, and ECA results. In this embodiment ECA data would become part of a knowledge base and clauses to an inference engine would be made based on ECA states obtained from analysis.

In another preferred embodiment, an ECA host computer may be separate from the IVR. This may be desirable as a way to either reduce real time processing load on an IVR or as a way of controlling a software environment of an IVR system. The latter is a common issue in hosted IVR platforms such as those offered by Verizon or AT&T. In another preferred embodiment an ECA host computer receives its voice stream by physically attaching to a telephony interface. Session coordination information is then passed between an IVR host and ECA host (if necessary) to properly coordinate an association between call and sessions in both machines.

### BRIEF DESCRIPTION OF THE DRAWING FIGURES

FIG. 1 is a block diagram showing systems and their interconnections of a preferred embodiment of the invention.

FIG. 2 is a more detailed view of processes and their interconnections as related to a Voice Response Unit (VRU—another name for IVR) and its surrounding systems, according to an embodiment of the invention.

FIG. 3 is a diagram showing functional processes and their intercommunication links, according to an embodiment of the invention.

FIG. 4 is a diagram showing ECA processes according to the invention, hosted in a separate server.

FIG. 5 is a diagram showing ECA processes according to the invention, in a batch mode hosted on a separate server from the VRU.

FIG. 6 shows interprocess messages and their contents, according to the invention.

### DETAILED DESCRIPTION

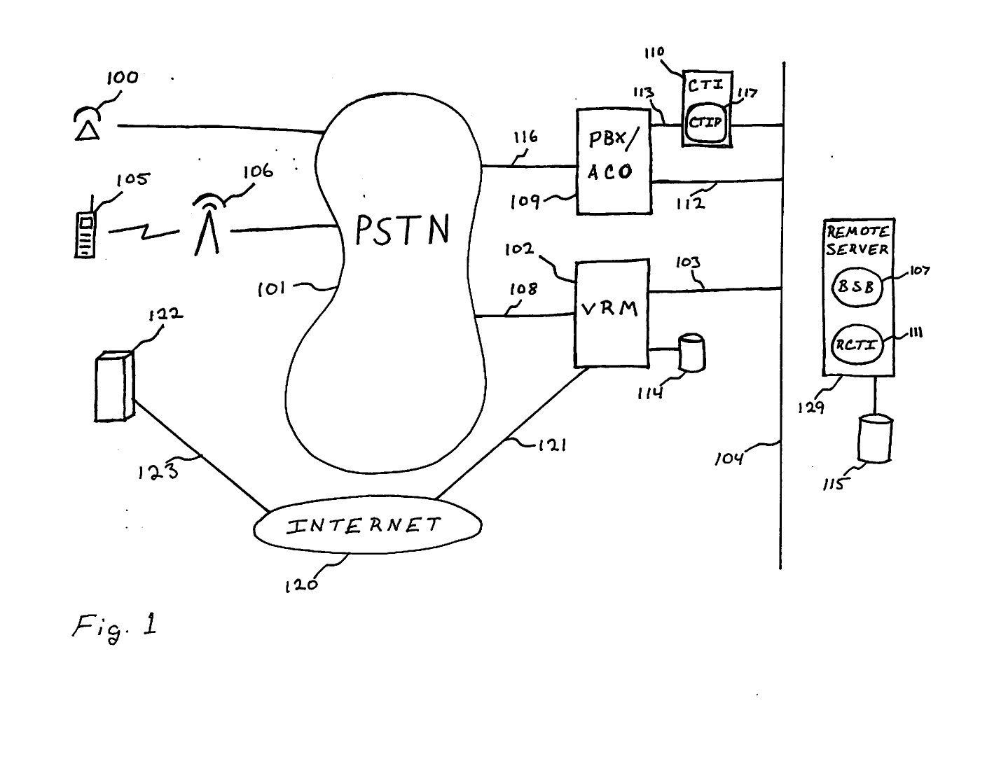

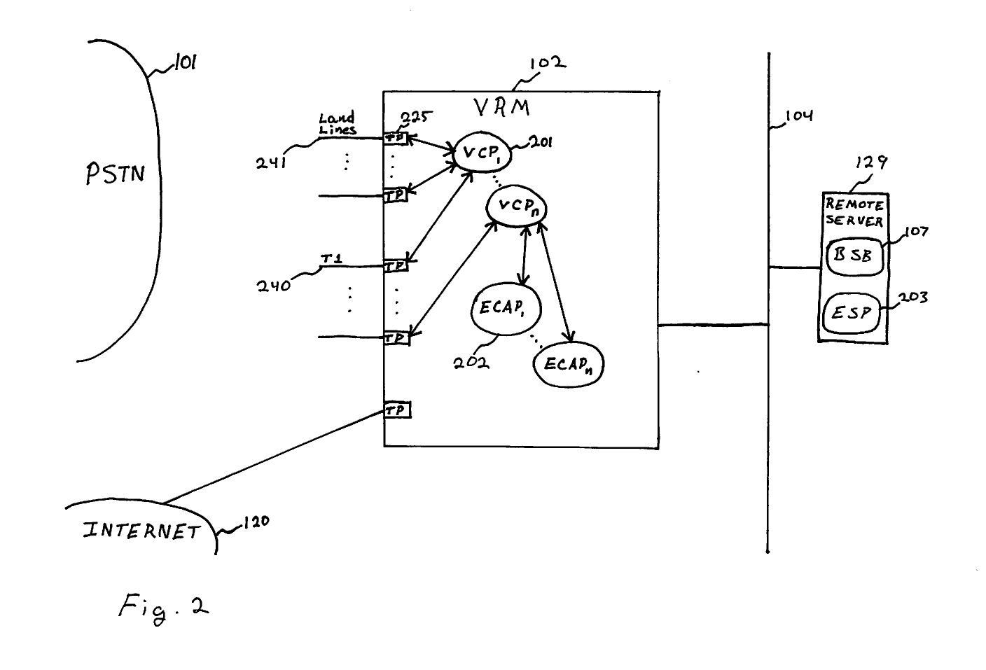

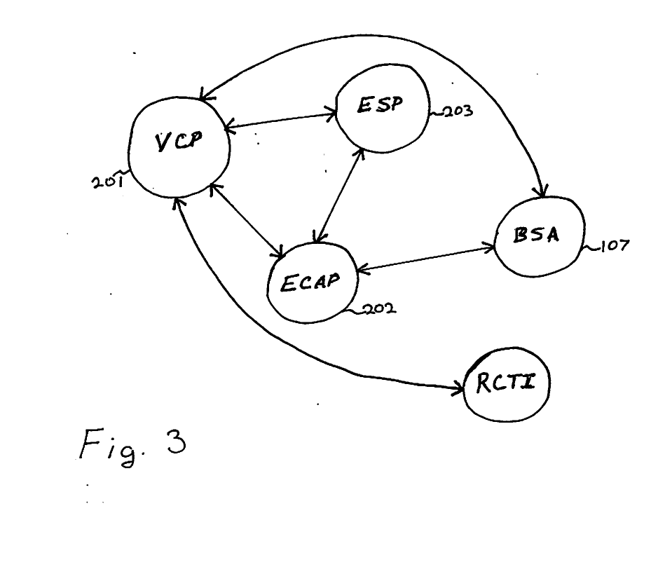

FIG. 1 shows calls originating from various telephone technology sources such as telephone handsets 100 connected to a network such as a Public Switched Telephone Network (PSTN) 101 or the Internet 120. These calls are routed, by an applicable network, to VRU 102. A preferred embodiment discussed below describes land line call originations and PSTN-connected telephony connections such as T1 240 or land line 241, although any other telephony connection would be as applicable, including internet telephony, and indeed any other source of streaming audio could be used instead of telephony, for example audio embedded within a video.

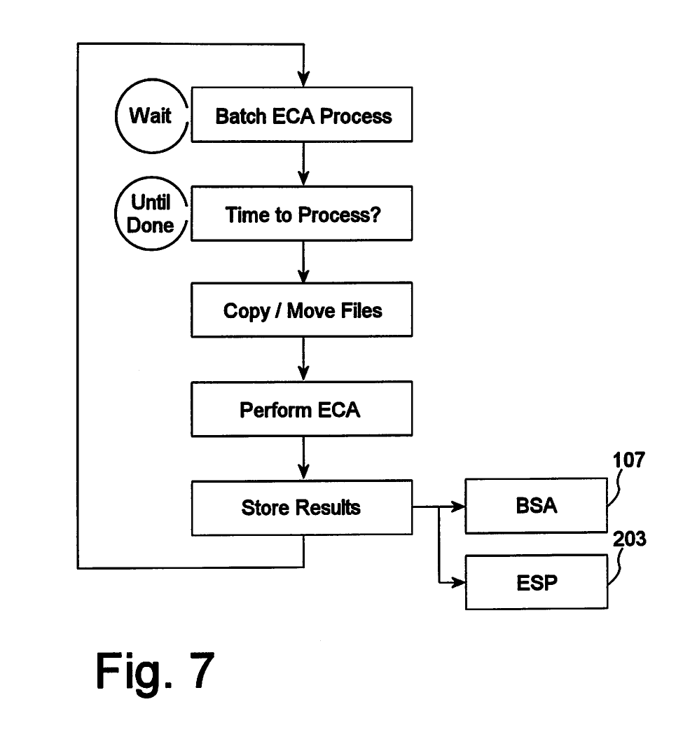

Once routed, calls appear at VRU 102 where they are answered by a VRU Control Process 201 (VCP) monitoring and controlling an incoming telephony port 220. Caller information may be delivered directly to telephony port 220 or obtained via other methods known to those skilled in the art. In a preferred embodiment caller speech is analyzed in real time. VCP 201 is logically connected to an Emotion Content Analysis Process 202 (ECAP) whereby a PCM (or other audio) stream of an incoming call is either passed for real time processing or identification information of a hardware location of this stream is passed for processing. In any case, VCP 201 sends a START_ANALYSIS message (as described with reference to FIG. 6 below) to ECAP 202 telling it to begin analysis and giving it data it needs to aid in analysis such as Emotional Context Data (ECD). This data may be used by ECAP to preset ECA algorithms for specific emotional types of detection. For instance, keywords such as “Emotional pattern 1” or “Emotional pattern 2” can be used to set algorithms to search for presence of patterns from earlier speech research for an application.

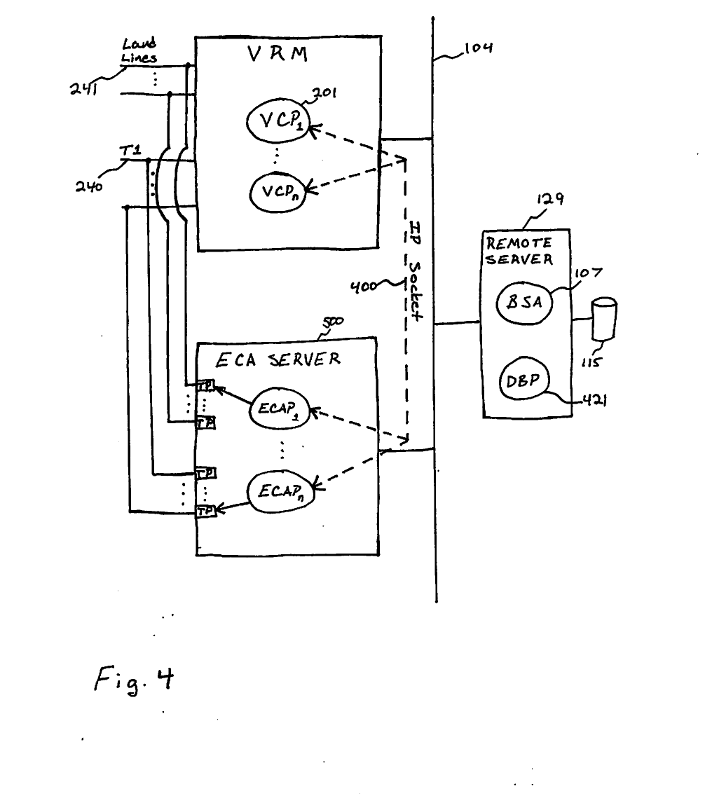

After receipt of this message, ECAP begins analysis of caller audio in real time. ECD may be used in an ECA technology layer to provide session-specific context to increase accuracy of emotion detection. ECA analysis may generate ECA events as criteria are matched. Such events are reported to other processes, for instance, from ECAP 202 to VCP 201 via ANALYSIS_EVENT_ECA messages (as described in FIG. 6). FIG. 3 shows other processes with reporting relationships to ECAP 202. These relationships may be set up at initialization or at the time of receipt of the START_ANALYSIS_ECA message through passing of partner process ID fields such as PP1 to PPn as shown in FIG. 6. ECAP 202 uses these PP ID fields to establish links for reporting. Partner Processes may use ECA event information to further the business functions they perform. For instance, Business Software Application (BSA) 107 will now have ECA information for callers on a per prompt response level. In one example, reporting of ECA information could lead BSA 107 to discovery of a level of stress reported at statistically significant levels in response to a specific prompt or prompt sequence.

Analysis continues until VCP 201 sends a STOP_ANALYSIS message to ECAP 202 or until voice stream data ceases. ECAP 202 completes analysis and post processing. This may consist of any number of communications activities such as sending VCP an ANALYSIS_COMPLETE message containing identification information and ANALYSIS_DATA. This information may be forwarded or stored in various places throughout the system including Business Software Application 107 (BSA) or Expert System Process 203 (ESP) depending upon the specific needs of the application. The VCP process then may use the results in the ANALYSIS_DATA field plus other information from auxiliary processes mentioned (BSA 107, etc.) to perform logical functions leading to further prompt selection/creation or other call processing functions (hang up, transfer, queue, etc.).

FIG. 4 shows a preferred embodiment of the invention whereby ECAP 202 processes are hosted in a separate server from the VRU. This is sometimes necessary to preserve the software environment of the VRU or to offload processing to another server. In any case, voice stream connectivity is the same and is typically a TCP/IP socket or pipe connection. Other streaming data connectivity technologies known in the art may be substituted for this method. Additionally, direct access to voice data may occur through TP 401 or TP 405 ports in the ECAP 202 for conversion of voice signal from land line or T1 (respectively) to PCM for analysis.

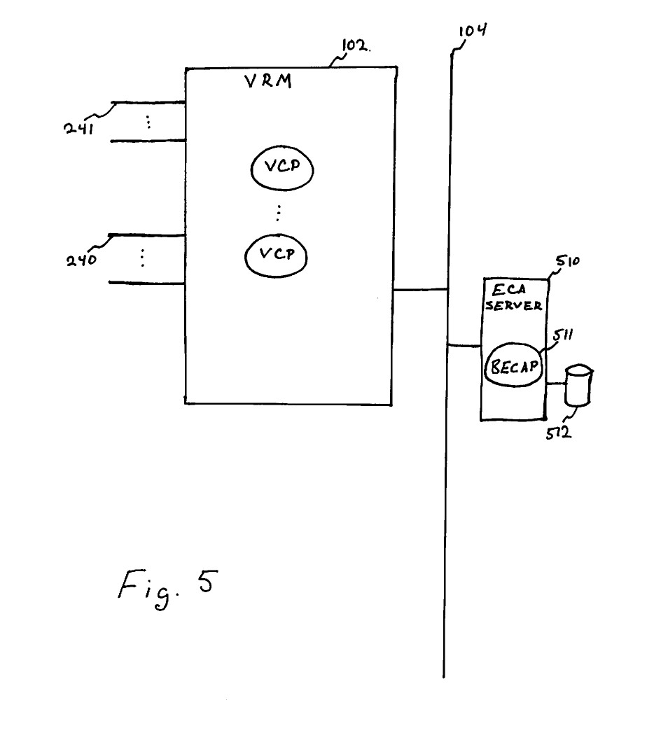

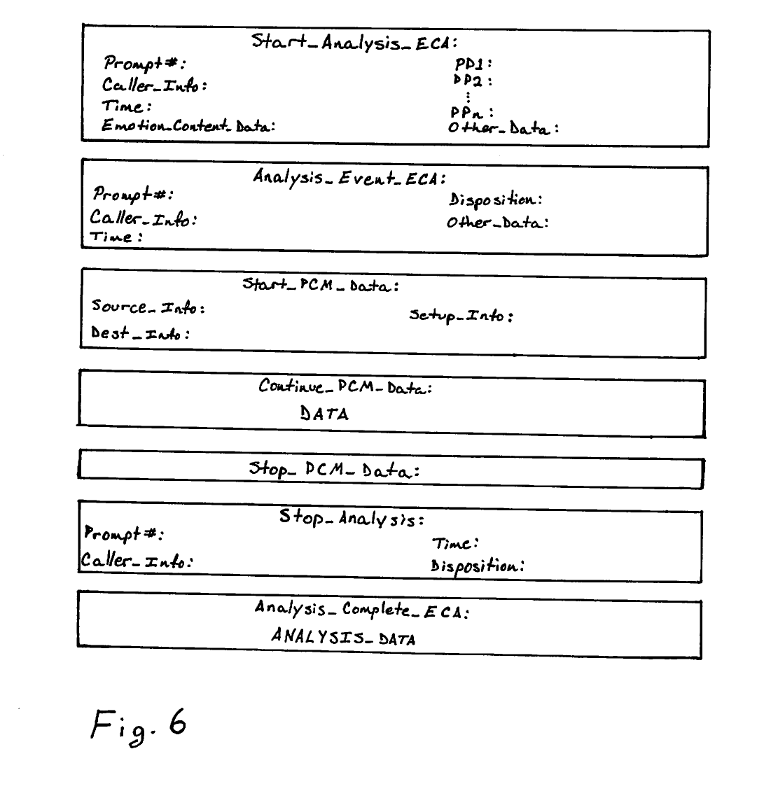

FIG. 5 shows a preferred embodiment of the invention for batch mode operation. Many customers have simple prompt needs and only want speech analyzed in batch from recorded files on a periodic basis with results reported at the end of that period. Batch mode supplies this functionality. In this embodiment VCP processes record speech as it occurs in call sessions. Information that was contained in a START_ANALYSIS message is stored with a corresponding audio sample in a file or in an associated database like database platform (DBP) 421. Periodically, often at night, these files are copied or moved to batch server 510, where they are analyzed by Batch ECA Process 511 (BECAP). This process performs for example the steps shown in FIG. 7. Reporting from BECAP 511 may be to the same type and number of Partner Processes described in the real time scenario described above.

What is claimed is:

1. A system for automated analysis of emotional content of speech, comprising:
an apparatus for receiving and processing audio streams;
an apparatus for storing and playing pre-recorded or synthesized prompts and for storing speech responses;
an apparatus for interconnecting computers; and
an apparatus for performing emotional content analysis.

2. A method for automated analysis of emotional content of speech, comprising the steps of:
(a) routing calls via a network such as a public switched telephony network (PSTN) to an IVR system;
(b) answering calls at the IVR system;
(c) playing one or more audio prompts;
(d) receiving customer speech from callers in response to prompts;
(e) storing the customer speech in one or more data files;
(f) moving the data files in batch mode to a server hosting emotional content analysis software;
(g) analyzing a portion of the customer speech to determine at least emotional content of the customer speech; and
(h) creating reports summarizing results from a plurality of emotional content analyses.
